(19) United States
(12) Patent Application Publication
(10) Pub. No.: US 2018/0337880 A1
(43) Pub. Date: Nov. 22, 2018

(54) SYSTEM AND METHOD FOR PRESENTATION OF CONTENT LINKED COMMENTS

(71) Applicant: ANNOTO LTD., Petah Tikva (IL)

(72) Inventors: Genadi SOKOLOV, Rishon Le Zion (IL); Kirill SLAVKIN, Petah Tiqwa (IL); Hen EYTAN, Ramat Gan (IL)

(73) Assignee: ANNOTO LTD., Petah Tikva (IL)

(21) Appl. No.: 15/776,793

(22) PCT Filed: Nov. 15, 2016
(86) PCT No.: PCT/IL2016/051231

§ 371 Date: May 17, 2018

Related U.S. Application Data
(60) Provisional application No. 62/256,725, filed on Nov. 18, 2015.

(51) Int. Cl. H04L 12/58

(52) U.S. Cl. CPC H04L 51/16; G06F 3/04845; H04L 51/32

(57) ABSTRACT

Embodiments of the invention include a method and a system for displaying a discussion thread related to a progress enabled media comprising providing, by one or more media content providers, a progress enabled media to a client via a communication network, collecting, by a commenting system provider, information related to the progress enabled media, determining, by the commenting system provider, a unique identifier of the progress enabled media and providing, by the commenting system provider, a discussion thread related to the progress enabled media according to the unique identifier. Further the method and a system includes displaying, by the commenting system provider, the discussion thread to a user, wherein a link between the discussion thread and the progress enabled media is independent from the one or more media content providers.

### FIELD OF THE INVENTION

The present invention relates generally to system and method for presentation of comments related to progress enabled media. More specifically, the present invention relates to interactive presentation of content linked comments.

### BACKGROUND

Commenting systems allowing users or clients to add or insert a comment or to share other information are becoming an integral part of various applications such as internet websites, mobile applications, social networks and the like. Commenting systems allow users to comment on a plurality of content objects, e.g., video, photo, text message and the like and a plurality of comments on the same content may create a discussion or a thread of comments related to a certain content object. Those discussions are usually separated from the content object itself. For example in websites, the discussion is usually placed at the bottom of the web page.

In the field of progress enabled media, especially in media such as video, it is common that the media or content is hosted by one or more major providers, for example, YouTube, Vimeo and the like. When playing content via a certain application, a user may view comments entered by other users who uses only the same application for playing the video. For example, if a certain video is hosted by two different providers or websites two separate discussion threads may exist even if a single third party commenting system is used by both websites. There is a need to provide a unified solution to enable a universal commenting system that links comments to content.

### SUMMARY

Embodiments of the invention provide methods and process which allow users to interact with media content, to generate content which may be interconnected to the media and may be shared across the web. Embodiments of the invention may allow for an interactive commenting system that enables interactive user experience with progress enabled media, for example, interactive discussion between users in relation to a video.

According to embodiments of the invention, a global commenting system may link a media discussion thread to a certain progress enabled media such that a single commenting system is shared across all websites, applications and providers. It may allow linking a media discussion thread to progress enabled media by using a media identifier as opposed, for example, to using a web page, a Uniform Resource Locator (URL) or a specific application. It may assure that the same media discussion thread will be used in all of the websites or applications allowing more effective user generated content sharing and collaboration.

A progress enabled media may be a fragment, part or a piece of another larger progress enabled media. Embodiments of the invention may link between one or more fragments and a larger progress enabled media which contains the one or more fragments. Once a link is made between different progress enabled media fragments, each having its own media identifier and media discussion thread, the fragments may be grouped into a media group and given a media group identifier. All the media discussion threads of the group may be used for each member of the media group allowing an effective user generated content sharing and collaboration.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a global commenting system according to embodiments of the present invention;

FIG. 2A is a schematic representation of a progress enabled media and associated comments according to embodiments of the present invention;

FIG. 2B is a schematic representation of a sub-conversation according to embodiments of the present invention;

FIGS. 2C-2D are schematic representations of histogram (stacked bars) progress lines according to embodiments of the present invention;

FIG. 3 is a flowchart of a comments presentation method according to embodiment of the present invention;

FIG. 4 is a schematic illustration of comments presentation on time based progress line according to embodiments of the invention;

FIG. 5A is a schematic representation of a comments user interface according to embodiments of the invention;

FIGS. 5B-5E are schematic representation of features of comments user interface according to embodiments of the invention;

FIG. 6 is a schematic illustration of exact match of two media segments according to embodiments of the invention;

FIG. 7 shows a schematic illustration of contained media segments according to embodiments of the invention;

FIG. 8 is a schematic illustration of overlapping media segments according to embodiments of the invention;

FIG. 9 is a schematic illustration of a combined media group progress line according to embodiments of the invention;

FIG. 10 is a flowchart of media grouping method according to embodiment of the present invention;

FIG. 11 shows a flowchart of a comments presentation filtering process for grouped media according to embodiment of the present invention; and

FIG. 12 is a high level block diagram of an exemplary computing device according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Although embodiments of the invention are not limited in this regard, the terms “progress enabled media” or “content media” as used herein refers to any stream or flow of data, content, content objects, or any information such as video, audio, slides, pictures and the like. The terms refer to any content whose flow or progress may be tracked, followed, measured or monitored using a plurality of units such as time, percentage, fragments and the like.

The term “progress line” as used herein refers to any line, mark or track that represents progress of media, e.g., progress enabled media. For example for video or audio a timeline may be considered a “progress line”, for slide show or a photos presentation the progress line may include a notation or marking of the plurality of slides spread along the progress line.

The term “media identifier” as used herein relates to a unique identifier, classification or recognition parameter related to a specific content media. Examples of media identifier may include but are not limited to Uniform Resource Locator (URL), identification (ID) such as, for example, YouTube ID or Vimeo ID.

The term “media discussion thread” as used herein refers to any data, information, knowledge or content related to a media identifier, for example, comments, messages, votes, participating users, metadata and the like. A media discussion thread may be displayed to a user in conjunction with the presentation of the content media to which it relates, e.g., while a user view a certain content media as well as the related media thread. In some embodiments a user may insert a new comments to the media discussion thread while viewing previous inserted comments in the media discussion thread.

A system and method according to embodiments of the invention may allow global managing and controlling of a commenting system. Embodiments of the invention may allow interactive commenting system that enables interactive user experience with progress enabled media, for example, an interaction between a user and a media content. A user interaction may include one or more actions, engagements, activities and events, for example, displaying comments to the user, receiving comments from a user, voting, e.g., up vote comment (e.g., like), down vote comment, flag comment indicating a fact, e, g, spam flag and social activities, for example, sharing to social networks or sending an e-mail, follow users, follow discussion threads, and follow sub-conversations.

According to embodiments of the invention, a global commenting system may link a media discussion thread to progress enabled media such that a single commenting system is shared across all websites, applications and providers for a certain media. Linking a media discussion thread to progress enabled media by using a media identifier may be contrasted with, for example, using a web page, a Uniform Resource Locator (URL) or a specific application. For example, embedding the same progress enabled media using a global commenting system by a plurality of websites or applications, as described in embodiments of the invention, may ensure that a same media discussion thread will be used in all of the websites or applications allowing more effective user generated content sharing and collaboration.

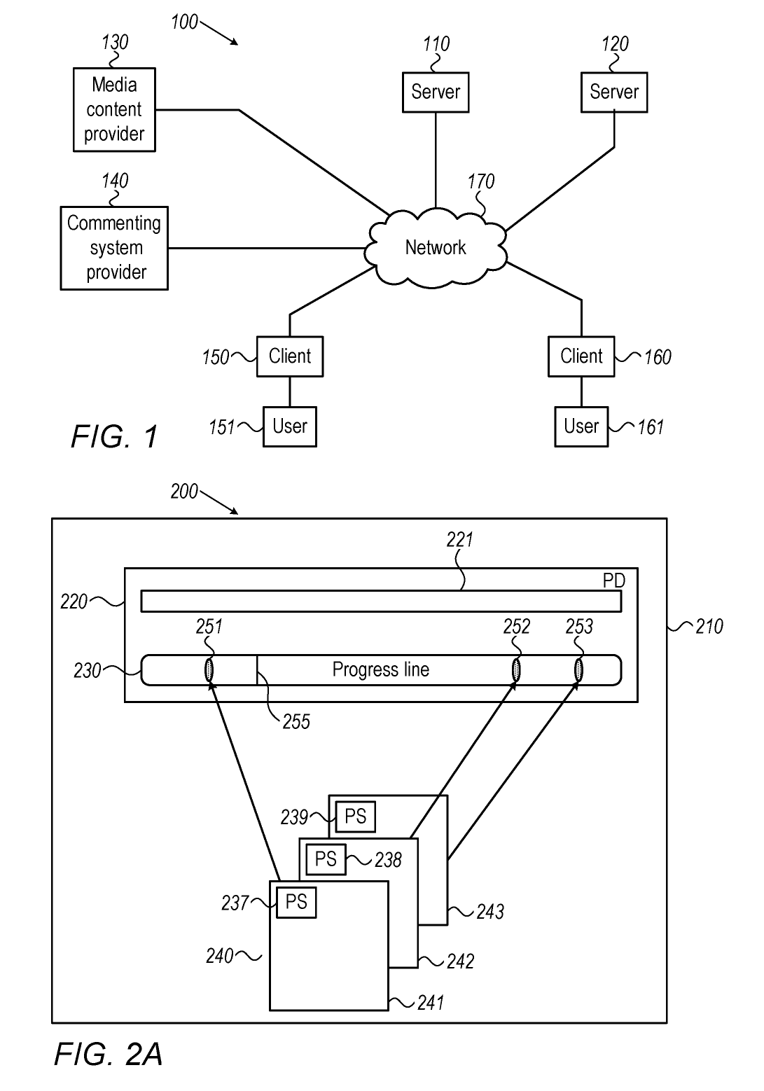

Reference is made to FIG. 1 that shows a global commenting system according to embodiments of the present invention. Global commenting system 100 may include one or more servers 110 and 120, a media content provider 130, a commenting system provider 140 and one or more clients 150 and 160, all connected to a network 170. Users 151 and 161 may use, operate, activate or control the one or more clients, e.g., client 150 and/or client 160 in order to communicate with one or more servers 110 and/or 120, media content provider 130 and commenting system provider 140 via network 170.

Network 170 may be any communication network, for example, a local network, a wide-area network, the Internet network, wired network or wireless network. Any other suitable communication network or a plurality of communication networks may be use. Clients 150 and 160 may be any computer device which may be connected to network 170, for example, a cellular telephone, a tablet computing device, a personal computer, a mobile computer and the like.

Client 150 and client 160 may each be connected to one or more servers, e.g., server 110 and/or server 120 in order to load one or more web pages or retrieve one or more applications. The application being presented to client 150 may include embedded content enabled media, such as, for example, a video embed. The application or webpage being presented to client 150 may further include embedded software related to commenting system provider 140. Any other content enabled media may be presented to user 150. Servers 110 and/or 120 may provide application programming interface (API) which may be used by client 150 and/or 160.

The content enabled media may be streamed from media content provider 130 or directly from servers 110 and/or 120. According to some embodiments of the invention, media content provider 130 may be a stand-alone module, in some embodiments media content provider 130 may be implemented as an integral part of a server, e.g., server 110 or server 120, while in other embodiments media content provider 130 may be connected or coupled to a server, e.g., server 110 or server 120. Media content provider 130 may provide client 150 with progress enabled media directly or via another server. For example, video data may be streamed to client 150 via server 110, via server 110 and server 120 or directly from media content provider 130. Client may receive in parallel, simultaneously at the same time while receiving progress enabled media, information from commenting system provider 140, e.g., a software code such as a JavaScript for example. The received software from commenting system provider 140 may gather and collect information regarding the video player and the requested commenting service from the application e.g, from a media player or a web application and may further request further information, software or resources from commenting system provider 140, e.g., additional JavaScripts and the like. The additional software may generate a graphical user interface (GUI) presenting the commenting system to user 150, and may determine which information or content to request from commenting system provider 140.

Commenting system provider 140 may provide a commenting service linked to the progress enabled media presented to client 150. In some embodiments of the invention commenting system provider 140 may be implemented as an integral part of media content provider 130. In other embodiments it may be implemented as an integral part of a server, e.g., server 110 or server 120, while in other embodiments commenting system provider 140 may be connected or coupled to one or more of media content provider 130, server 110 or server 120.

Client 150 may load web pages from, for example, server 110. The webpages may include or embed a content enabled media, such as a video. Client 150 may determine a media identifier of the embedded video. The media identifier may be determined by a code, e.g, Javascript, running on client 150 for example, by using an embedded video player, Javascript application programming interface (API) or by any other method as is known in the art. Determination of the media identifier of the progress enabled media or content media may be performed in some embodiments of the invention, partially or fully by one or more application servers, e.g., server 110 and/or server 120 and/or commenting system provider 140. In some other embodiments such additional data may be provided to the client during application loading stage.

Once having the media identifier of the content media, client 150 may query commenting system provider 140 to provide the comments related to the specific media identifier and then client 150 may display the comments to user 151. In some embodiments of the invention, the comments related to the media identifier may be transferred to client 150 partially or fully by one or more application servers, e.g., server 110 and/or server 120 while additional data may be provided to client 150 during application loading stage.

According to some embodiments of the invention, client 150 or application server 110 may load code, data or information from the commenting system provider 140 which may allow client 150 to perform the determination of the media identifier and the query of the comments or perform them automatically.

Although embodiments of the invention are not limited in this respect, a media group identifier may be a unique identifier that identifies a media group. A media group may be defined as two or more content enabled media items. Content enabled media which is identified by a media identifier may be part of a media group having a media group identifier. When a media identifier is related to progress enabled media that is related to a media group, commenting system provider 140 may respond and provide client 150 with comments related to all the progress enabled media items of the group and not only to a single content media.

Client 150 or server 120 may request from commenting system provider 140 specific comments or a specific way of comments presentation, for example, according to an API defined by commenting system provider 140. Exemplary requests for comments presentation may include, a defined number of comments according to date, rate or other criterion, for example, a limited number of comments starting from the most recent one, a limited number of comments starting from the comments with the highest rating, comments corresponding to section of the media progress line, comments filtered by author, comments filtered by keywords, comments including or not including discussions from other media items of the group or by other any other criterion. Any other request for comments presentation or any combination of requests for comments presentation may be defined, according to embodiments of the invention.

In some embodiments of the invention, commenting system provider 140 may create a new media discussion thread related to a specific media identifier, may reject or accept a request from client 150 and give appropriate response to a request from client 150. The decision of commenting system provider 140 may be based on a plurality of rules and information, for example, according to user access rights, origin of application server and the like.

A global commenting system 100 may improve the experience of viewers such as users 151 and 152 by a specific display manner of comments as described in embodiments of the invention. Comments may be displayed together with or in conjunction with progress enabled media.

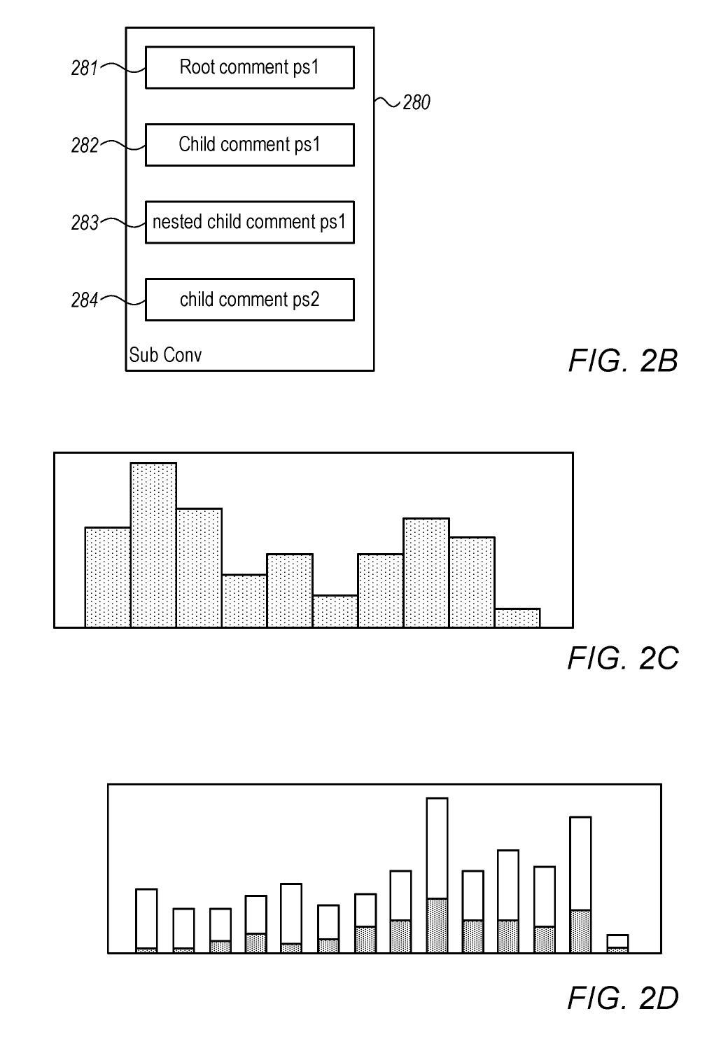

FIG. 2A is a schematic representation of a progress enabled media and associated comments according to embodiments of the present invention. Schematic representation 200 may be presented to a user of the commenting system, e.g., user 151 of commenting system 100 of FIG. 1. Schematic representation 200 includes a user interface 210 which may be represented to a user on a screen of any end user device having a screen, for example, a laptop, a smartphone, a computer, a PDA, a tablet and the like. User interface 210 may include a representation of the progress enabled media, also referred to herein as “progress enabled media window” 220 which is linked or connected to a representation of a progress line 230 and a representation of a media discussion thread 240. While the length of progress line 230 may indicate the entire duration of the represented progress enabled media 220, a pointer 235 or any other mark or indication on progress line 230 may indicate a current point in time within the duration of progress enabled media 220, for example, the point the a user is currently watching progress enabled media 220.

Media discussion thread 240 may include a plurality of comments, 241, 242 and 243. It should be understood to a person skilled in the art that the number of comments shown is an exemplary number and any number of comments may be presented to a user in user interface 210. A comment may include for example text input by a user related to a subject, but may include other information or data in other formats. Each comment of comments 241, 242 and 243 may be linked to a specific point in progress line 230. Progress line 230 may be presented in a manner that fits the media being presented in progress enabled media window 220. For example, if the content presented is a slide show, the representation of progress line 230 may be fragmented while if the content presented is a video, the representation of progress line 230 may be continuous. Any other representation method may be used, for example as represented in FIG. 2C and FIG. 2D.

FIG. 2C and FIG. 2D are schematic representations of histogram (stacked bars) progress lines according to embodiments of the present invention. Although embodiments of the invention are not limited in this respect, in some embodiments the progress line may be represented by a histogram in order to allow a better representation of certain attributes. For example in FIG. 2C each rectangle may be colored with different color, each of which may represent emotion, category or any other parameter or information while in FIG. 2D each rectangle may include more than one color each may represent emotion, category, user or any other information.

According to embodiments of the invention, each comment is attached to, or linked to, a given progress stamp (PS). The PS may link a comment to a specific point on progress line 230. Reference is made back to FIG. 2A. For example, PS 237 links comment 241 to point 251 on progress line 230, PS 238 links comment 242 to point 252 on progress line 230 and PS 239 links comment 243 to point 253 on progress line 230. A PS may represent a plurality of units, depends on the type of the progress enabled media. For example, a PS may be represented in seconds for a media item which uses time to measure playback progress such as, video or audio data while a PS may be represented by a fragment number for fragment based media items such as slides or a presentation. A PS is linked to a comment and saved alongside with it in commenting system databases of commenting system provider, e.g., commenting system provider 140 of FIG. 1.

According to embodiments of the invention, a media discussion thread may be linked to a progress duration (PD), be associated with a PD or include a PD 221. PD 221 represents the duration of progress enabled media 220 and may represent a plurality of units, depending on the type of the progress enabled media. For example, PD may be represented in seconds for a media item which uses time to measure playback progress such as, video or audio data or a PD may be represented by a fragment number for fragment based media items such as slides or a presentation. Usually, same units may be used for both PS and PD. The PD is linked to the media discussion thread and saved alongside with it.

For example, for progress enabled media which includes video or audio PS may represent time in seconds, e.g., a time counted from the beginning of the media playback while PD may represent the total duration of the progress enabled media in seconds. For example for video/audio track with duration of 2 minutes PD may be 120 seconds and the PS may be between 0 to 120 seconds. For progress enabled media which includes slides the PD may represent the total number of slides and the PS may represent a single slide number. Although embodiments of the invention are not limited in this respect, the following relation may exist between the values of PS and PD: 0<=PS<=PD. Embodiments of the invention may use information regarding the duration of the progress enabled media from the software being used to play the media, e.g, the video or audio player. The PD may be obtained from the player as well as PS for the comments.

The term “root comment” as used herein refers to a comment that was created with a direct relation to a progress enabled media. A root comment may be the first comment for the media. A root comment is a comment that stands for itself since it is not related to previous comment, e.g., it is not a reply or response to another comment. A root comment does not have an ancestor comment and is not a child comment to any other comment. The term “child comment” as used herein refers to a comment that was created in response or as a reply to another comment and the term “ancestor comment” as used herein refers to a comment which another comment is related or refers to it. For example, a root comment is an ancestor comment to a child comment.

The term “sub-conversation” as used herein refers to two or more comments related to each other. A sub-conversation may include, for example, a root comment and one or more children comments or other data related to it, e.g., comments, votes, participating users, metadata and the like.

The term “comment” as used through embodiments of the invention may refer to one or more comments. Comments typically include text and text-related objects, e.g. emoticons, but may include any other data. It should be clear to a person skilled in the art that the representation of comments as used herein as single comment and as a separate entity is for simplicity of explanation and a comment may represent a structure of comments that may have a plurality of different relations between one comment to another comment, for example, a media thread may be a complex tree of a plurality of comments organized as sub conversations as shown, for example in FIG. 2B.

FIG. 2B is a schematic representation of a sub-conversation according to embodiments of the present invention. Sub-conversation 280 may include for simplicity four comments 281, 282, 283 and 284, however, any number of comments may be included in a sub-conversation. Comment 281 may be a root comment and may receive a certain value of PS, indicated as PS1. Comment 282 is a child comment to root comment 281 and therefore may receive the same PS value as the PS value of its ancestor comment 281, namely PS1. A comment 283 is a nested child comment which means it is a child comment to another child comment 282. Comment 283 receives the same PS value as the PS value of its ancestor comment 282, namely, PS1. Comment 284 is also a child comment to root comment 281 but may receive a PS value different from the PS value of its ancestor comment 281, indicated as PS2. Reference is made to FIG. 2A, it should be clear that in the exemplary illustration of FIG. 2A, a comment, e.g., comment 241 may be a sub-conversation, e.g, sub-conversation 280 of FIG. 2B.

When a comment is written by a user, e.g., user 151 of FIG. 1, a PS may be created for that comment. If the comment is a root comment, the PS of the comment may be obtained from the progress line and the PS may include the exact position on the progress line to which the comment is related to. A user may explicitly decide to set a custom value of the PS for the comment. For child comments, the PS may be obtained from the related ancestor comment, and may receive a PS identical to the PS of the related ancestor comment or equal to it. A user may explicitly decide to treat child comments as root comments in regards of PS assignment. In some embodiments, when a user is performing an action such as typing a new comment, replying to existing comment and the like, the streaming or display of progress enabled media may be paused in order to enable the user to focus on the content of the comment.

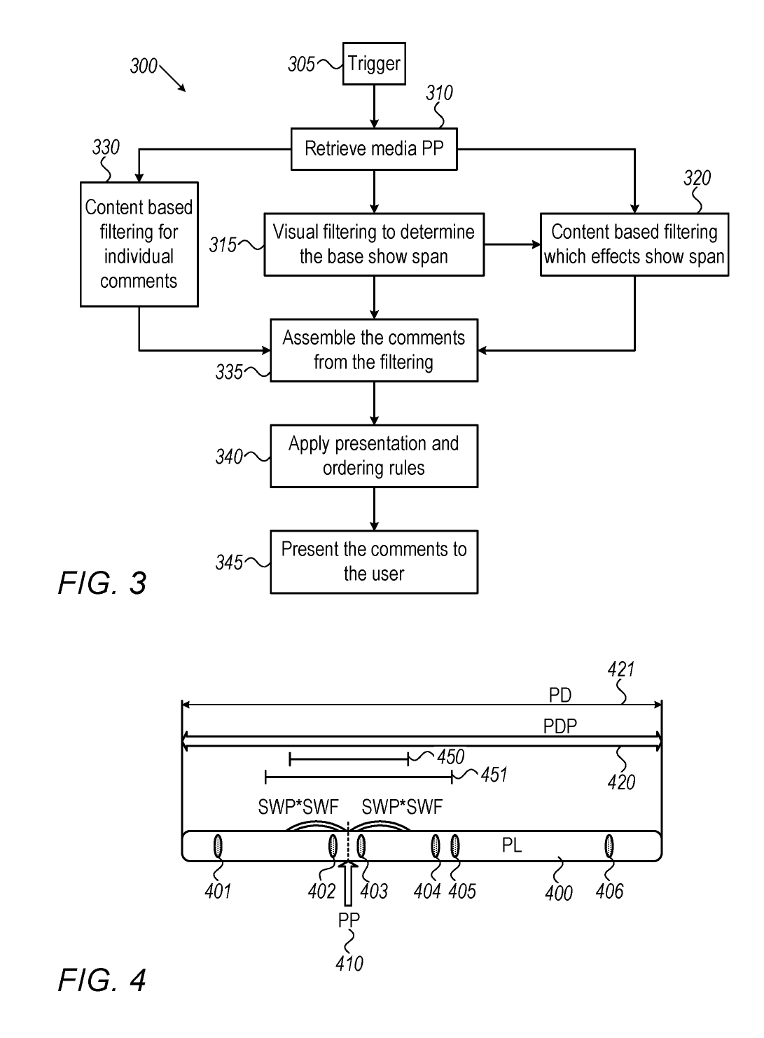

Reference is made to FIG. 3 which shows a flowchart of a comments presentation method according to an embodiment of the present invention. A user may play a progress enabled media, also referred to herein as a media segment or a track, which has one or more comments related to it. The comments may be obtained from the commenting system provider, e.g. commenting system provider 140 of FIG. 1. The decision if a certain comment is to be shown may be determined by performing, using or processing a comment presentation filtering algorithm which is described with reference to flowchart 300. The presentation filtering algorithm is triggered as indicated in box 305, by one or more triggers which may be manual or automatic triggers according to predetermined parameters. For example, it may be triggered according to a predetermined time frequency, for example, e.g., every 100 milliseconds, every 150 milliseconds and the like. The triggers may be action based triggers related to the progress enabled media, for example, each time the progress enabled media is stopped or played by a user, each time a click operation is performed by a user and the like. Any other automatic or non-automatic trigger may be used.

As indicated in block 305, the presentation filtering algorithm is triggered and the current time of the progress enabled media, also referred to herein as “progress position (PP), is retrieved or sampled from the media player playing the progress enabled media, as indicated in box 310. After sampling the PP, one or more processes are performed simultaneously, in parallel, one after the other or partially simultaneously and are described in boxes 330, 315 and 320. As indicated in box 315, visual filtering process is performed and in each of boxes 320 and 330, content based filtering processes is performed.

According to embodiments of the invention, a visual filtering algorithm allows a user to arrange the progress line in a manner that fits his needs by allowing intuitive interaction for reaching the best representation of the content enabled media along with the comments, for example, different screen sizes, different sizes of the progress line and different media durations. The visual filtering algorithm is described with reference to FIG. 4.

Reference is made now to FIG. 4, which is a schematic illustration of comments presentation on time based progress line according to embodiments of the invention. It should be clear to a person skilled in the art that the comment presentation method presented may be applicable to any progress line presented to a user, e.g., fragmented progress line such as for slides or continuous progress line such as for video data or audio data.

According to embodiments of the invention, progress line 400 is a visual representation of the progress of progress enabled media being presented to a user. Comments may be marked on progress line 400, for example, comments 401, 402, 403, 404, 405 and 406. Indication of the comments on the progress line may be presented by one or more observable comments indicators such as color different from the color of the progress line or other marked indications. For a given progress line, a user may expect to see comments related to a certain point by performing a click operation on the exact certain position of comment indicator on the progress line 400, e.g., by a mouse click, by a touch on a touch screen and the like. Such a click operation may be challenging for a user as spotting a certain spot on a progress line may be difficult if a large amount of comment indicators are located around a certain time and therefore around a certain point on progress line 400, or if the total duration of progress line 400 is very long.

Visual filtering may solve this by calculating and adjusting a variable or a parameter named “Showspan” based on the duration of the content enabled media and the length of the progress line in pixels which may also change. The Showspan variable represents the span of time represented or displayed for any given playback time. Showspan variable represent a span of time related to a certain position on progress line 400 for which comments should be shown or displayed to the user, e.g., for PP 410. Showspan is calculated by equation 1 as follows:

Showspan=MAX(MIN_SHOW_SPAN,ROUND(SWF*SWP*(PD/PDP))) Equation 1:

Wherein MAX(a,b): is the maximum between a & b and ROUND(value): rounds the value to the closest integer. Wherein MIN_SHOW_SPAN represents a constant for a minimum predefined span which may be measured in time units, for example, seconds for time based content media and wherein PD 421 represents the duration of the content enabled media in time units for example, measured in time units, e.g., seconds for time based content media. Wherein PDP 420 represents the progress duration of the content enabled media in pixels. Wherein SWP represents the shown width in pixels, namely the desired width in pixels for which comments are to be presented from both sides of PP and wherein SWF represents a width factor which is a predetermined constant factor, for example, a float positive number, such as 1, or other factor which may be determined based on the results of content based filtering process as described with reference to box 320 of FIG. 3. The SWF may control the presented show span. It should be clear that SWP and SWF may change or vary between applications.

Reference is made back to FIG. 3, in block 315, the visual filtering is applied and the Showspan parameter is being calculated. A PS of a comment is being checked and if the PP of the comment is within Showspan range 450 which is the range between (PP−ShowSpan) to (PP+ShowSpan) it is presented to a user as a result of the visual filtering. For example, in FIG. 4, comments 402 and 403 are located within Showspan range 450 and therefore presented while comments 401, 404, 405 and 406 are out of Showspan range 450 and therefore may not be presented to a user.

The calculation of Showspan which is indicated in box 315 may be performed using a predetermined first value of SWF, e.g., SWF=1.0, the result may be used in content based filtering process indicated in box 320, a new value of SWF may be determined for another calculation of Showspan 450, called Showsapn2 451, by a same formula with an updated value of SWF. In some embodiments, for example, when some comments are very long or have high rating and longer representation duration is required, comments may be assembled for a first duration represented by Showspan 450 but may be shown for a second duration represented by showspan2 451 while in other embodiments, for example, when a large number of comments is located in proximity to Showspan duration 450, comments may be assembled for a first duration represented by showspan2 451 and may be shown for the same duration represented showspan2 451.

In block 330, content based filtering is being applied for individual comments. Content based filtering may provide additional layer of locating relevant comments and presenting them to a user. Content based filtering may affect Showspan based on content check of comments and in addition may allow a selective comment presentation, for example, by showing specific sub-conversations and not all the comments located within a specific Showspan duration of time. The content based filtering process may include one or more algorithms, processes or steps that may locate comments which may be presented to the user because their content is relevant to a certain PP although their PS is not located within Showspan range 450.

For example, content based filtering may be based on subtitles. When a progress enabled media presented contains subtitles, text based comparison between comments and subtitles may be performed in order to define a matching factor that correlates between the content of the comment and the subtitles in the media. The matching factor or a “grade” may be given for each comment across the progress line and a matching threshold may be set either by a predefined decision or by a user configuration. Comments which have matching factor above the matching threshold may be presented to the user while comments which have matching factor below the matching threshold may not be presented to the user. A sub conversation of a comment with a matching factor above the matching threshold may be presented to the user as well. In some embodiments of the invention the progress enabled media may not include subtitles but the subtitles may be added or auto generated by a server, e.g., by commenting system provider 140 of FIG. 1, using techniques such as voice to text.

Other content based filtering methods may include calculating a weight for each PP in order to decide whether a comment should be presented to a user or not, for example, a higher weight parameter may expand the Showspan range for a specific PP. The calculated weight parameter may be calculated for each PP or for a series of PPs, with some intervals that may reduce the number of calculations e.g., for every second, third or fourth PP and the like. A plurality of factors may affect the calculated weight parameter, for example, the number of comments within a Showspan range, the number of votes related to comments within a Showspan range, comments which receive a high author rating within a Showspan range or according to comments length within a Showspan range. Any other factor or parameter may affect the calculated weight parameter.

As indicated in box 335, the comments that are determined to be presented based on the visual filtering process (in box 315) and the content based filtering process (in boxes 330 and/or 320) are assembled. According to embodiments of the invention, based on the visual filtering, a root comment and all comments related to it, e.g., its children comments, may be shown, presented or displayed if their PS is within the range of (PP−ShowSpan)<=PS<=(PP+ShowSpan)

In box 340, other presentation rules may be applied in order to decide if there are additional comments to be presented to the user. For example, according to embodiments of the invention, the following rules may be applied:
a. A child comment is presented by the same logic that a root comment is presented. In addition a child comment is presented if its ancestor comment is presented.
b. An ancestor comment is presented by the same logic that a child comment is presented. In addition an ancestor comment is presented if one of its child comments is presented.

According to some embodiments of the invention, visual filtering and content based filtering rules may not be applicable to a fragmented progress line. For example, according to embodiments of the invention, the following rule may be applied for a fragmented progress line, it should be understood that other rules may also be applied:
a. Comments and all their children and ancestors may be presented if the PS of the fragment equals the PP, e.g., if a comment PS equals 4 and PP, namely slide number equals 4, the comment is presented to the user.
   As presented in block 345, all comments that are determined to be presented as applied by the presentation rules are being presented or shown to a user.

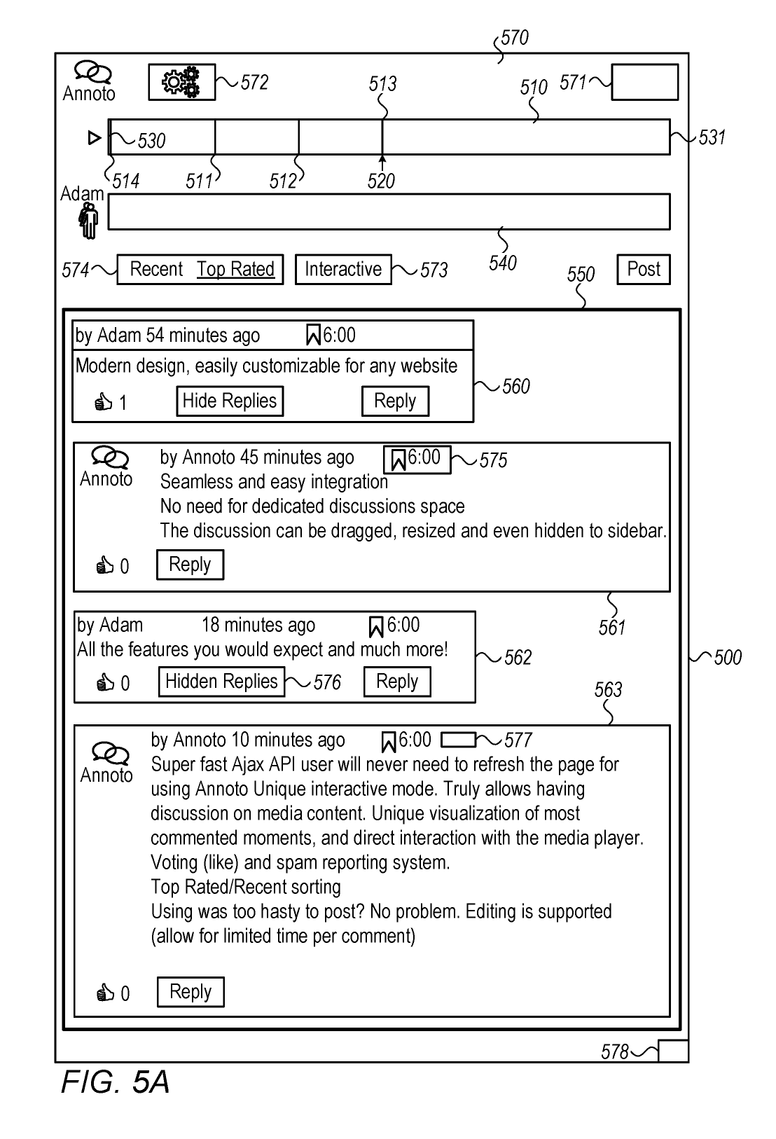

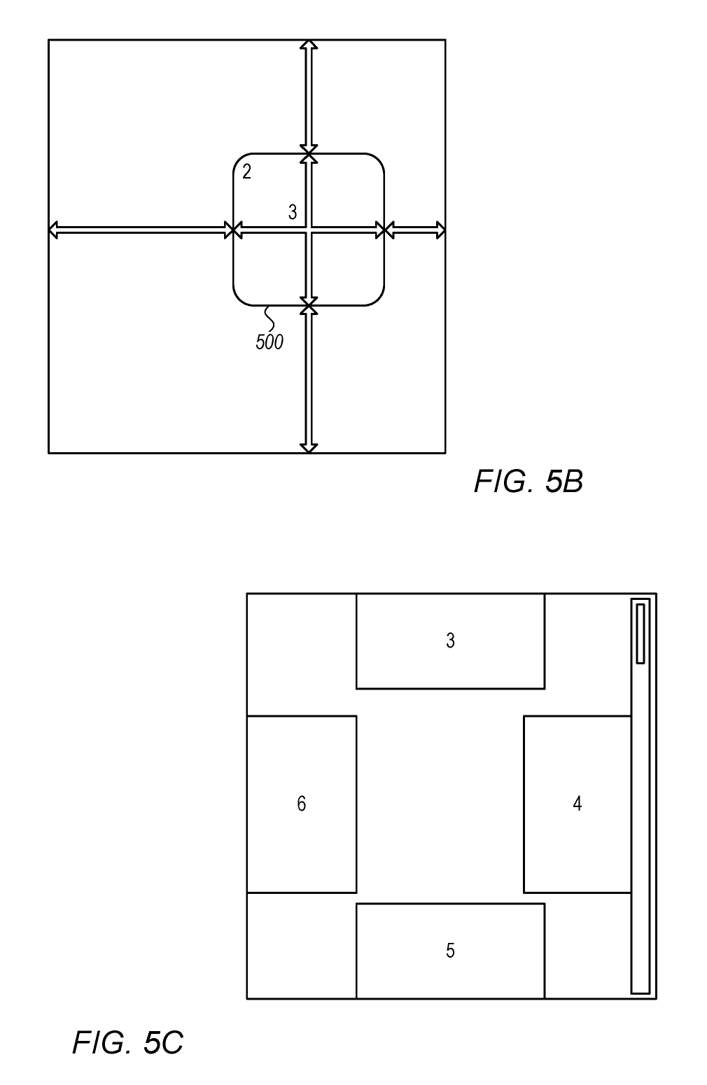

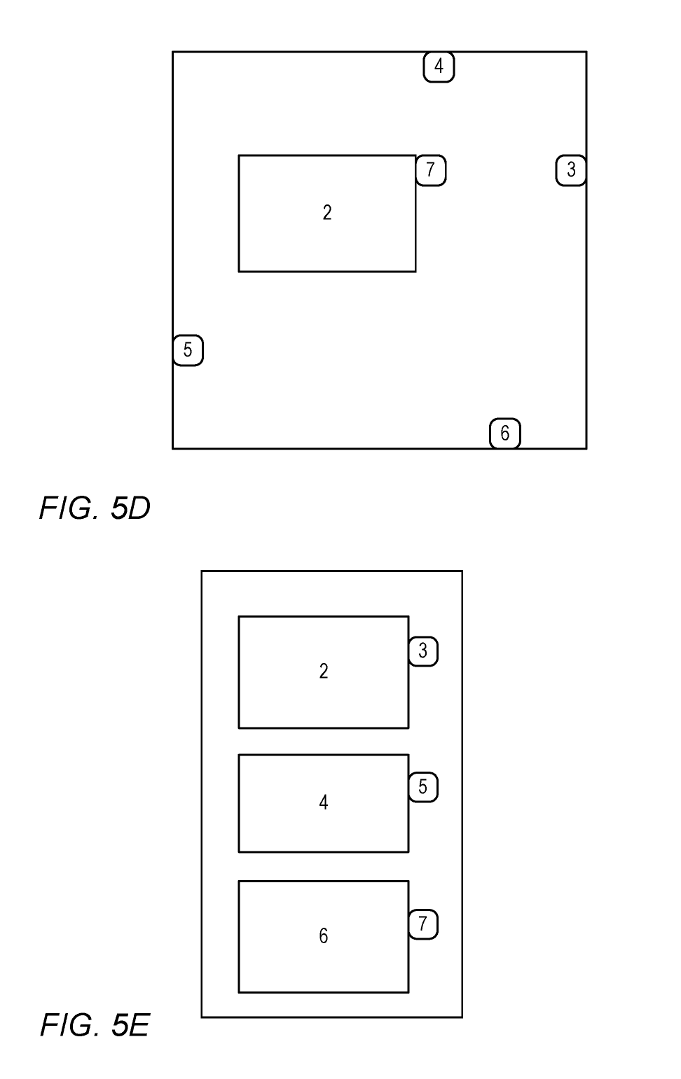

Reference is now made to FIG. 5A which is a schematic representation of comments user interface according to embodiments of the invention. Comments user interface 500 may include a progress line panel 510 to present the progress enabled media and may further include a comment creation field 540, where a user may insert or input a comment and a comment presentation screen 550 where comments 560, 561, 562 and 563 are presented to the user, e.g., shown to the user in block 345 of FIG. 3. The progress line panel 510 may be located under the media frame instead of the comments window

Progress line panel 510 may include one or more comment indicators 511, 512, 513 and 514, positioned on progress line panel 510 according to the PS of the comments. Comments indicators 511-514 may be visually highlighted on progress line 510, for example, may be marked in a different color or by a different marking. A progress position (PP) 520 indicating the current position of the playback of the content enabled media is also presented on progress line panel 510. Progress line panel 510 may allow users to visualize points of interest such as time of discussions, time of comments, votes, flags and the like while observing an overview of the entire progress enabled media (from point 530 to point 531) and without going through all of the progress enabled media. A user may choose to see all the comments related to the progress enabled media, regardless of the actual location of the progress position (PP).

The visualization of the comments, e.g., by comments indicators 511-514, on progress line panel 510 may allow efficient focusing of a user on points of interest in the progress enabled media. Different techniques or methods may be used for visualization such as different colors, distinct colors for special comments, e.g., author's comment, color saturation representing number of comments and/or votes in a certain point, the width of comments indicator may represent a number of comments and/or votes at a certain point, for histogram (stacked bars) representation of comments the color may represent emotion and the height number of comments and/or votes.

FIGS. 5B-5E show schematic representation of features of comments user interface according to embodiments of the invention. In some embodiments of the invention, an interactive user interface may be presented to the user, for example, by allowing one or more of the following features: comments user interface 500 may be a floating and/or draggable window or element, namely it may be embedded in any application window as a floating frame that may be dragged by the user and placed anywhere on the screen. In some embodiments of the invention, a placement of comments user interface 500 may be limited to a certain area on user screen or to specific points on user screen. Another embodiment may allow a transparent comments user interface 500 with variable opacity. In some embodiments comments user interface frame 500 may be resizable so that a user may resize comments user interface 500 horizontally and/or vertically according to his needs or according to application requirements as shown by arrows in FIG. 5B. The resize process may be performed directly by a user or automatically by, for example, the application while the content within is adjusted to fit the comments user interface 500 at any size.

In some embodiments, one or more of the inner elements inside comments user interface 500, e.g., comment presentation frame 550 or progress line panel 510 may be presented as a stand alone element or window and as such may be resizable and draggable as well. One or more comments may be displayed in a draggable and resizable window, that is located next to the progress enabled media. It should be understood to a person skilled in the art that comments user interface 500 and each one of its inner elements may have any size and may have any geometrical shapes, e.g., a square, a rectangle, a bubble, a rectangle with rounded corners, or any other shape. For example, progress line panel 510 may be visualized as rectangular progress bar, circuit (clock), hollow circuit (washer) and the like. One or more comments may be indicated by a visual indication and may be visualized on the progress line using comment indicators. Progress line panel 510 may be presented to the user as a histogram, for example a histogram where a color may represent emotions or categories of the comments and the like.

Comments user interface 500 may include number of areas for grabbing and dragging the comments user interface 500, e.g., area 570. Embodiments of the invention may allow a plurality options to control elements of comments user interface 500, for example, a control button 571 to automatically resize and fit comments user interface to screen and/or hide the comments user interface 500 into small widget, a control button 578 to manually resize comments user interface 500, a control button 573 to control turning on and off interactive presentation mode, control button 572 to reload comments and/or show a user menu. In some embodiments of the invention, other presentation options may be included such as comment date and time tag 575 which shows the absolute comment creation date and time and the progress stamp (PS) of the media progress line, a control 576 to hide or show a replies to a comment, an origin tag 577 which indicates the comment origin, e.g., in which application or website the comment was created, control button 574 for comment ordering and filtering options.

Other visualization methods may be applicable in some embodiments of the invention, for example, progress line panel 510 may be embedded in a playback progress bar of the media player, e.g., outside the comments user interface 500. In some embodiments, comments user interface 500 may be hidden when the progress enabled media is presented on full screen and may be shown per user trigger such as mouse move, touch of a touch-sensitive unit (e.g. touch screen), key press, etc. The comments user interface 500 may be hidden in any location on the screen, e.g., at the side, at the bottom or at the upper side of the screen or next to the progress enabled media object or media player and may be shown as a sidebar, widget or as an icon as presented, for example, by any one of elements 3-6 with relation to progress enabled media object 2 in FIG. 5D. Pressing the sidebar, widget or icon may reopen comments user interface 500. The sidebar, widget or icon may be dragged, horizontally, vertically or diagonally alone or in combination across the limited areas of the screen, e.g., edges of the screen, allowing relocation by the user. In some embodiments as presented in FIG. 5C, the comments user interface may be docked to one of the edges of the screen, e.g., the bottom 5, the top 3, the right 4 or the left 6 and the comments user interface may be resized and dragged along that edge. When the browser or application is scrolled the comments user interface position is not changed. In some embodiments, an action of a user on progress line panel 510, for example mouse over, a popup may be shown to the user with comments of that progress line point. The action may or may not cause the playback of the media to skip to that point of the media, namely updating the PP.

In some embodiments of the invention, multiple progress enabled media objects may be presented on a same browser or application window. When two or more progress enabled media objects, for example, two or more video players are presented on a single browser or application window, a separate media thread exists for each progress enabled media object, as presented, for example, in FIG. 5E. Each progress enabled media object may have its own hidden comments user interface into a sidebar, widget or icon which presents the comments related to that progress enabled media object. Each comments sidebar, widget or icon may be docked closed, attached or linked to its progress enabled media object. For example in FIG. 5E, widget 3 is docked to media object 2, widget 5 is docked to media object 4 and widget 7 is docked to media object 6. Each comments sidebar, widget or icon may be activated and opened into comments user interface for interaction separately or at the same time with other comments user interfaces.

Embodiments of the invention may allow linking and grouping comments related to two or more progress enabled media segments if same content is found in two or more progress enabled media. Media discussion threads of the two or more progress enabled media segments may be grouped based on identification of identical content which may be from different sources. The grouping of media discussion threads related to two or more progress enabled media segments may allow effective sharing and collaboration of user generated content. While each progress enabled media segment has its own media identifier and its own media discussion thread, once grouped into a single media group they are given a media group identifier in addition to their original media identifier.

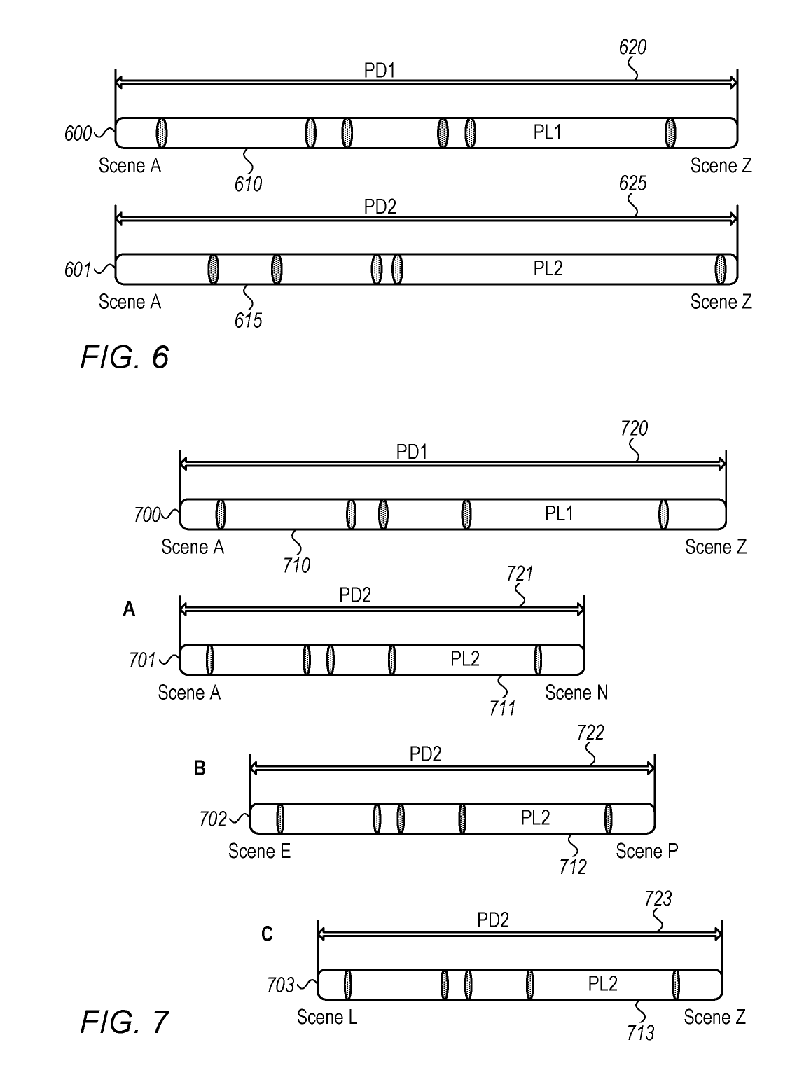

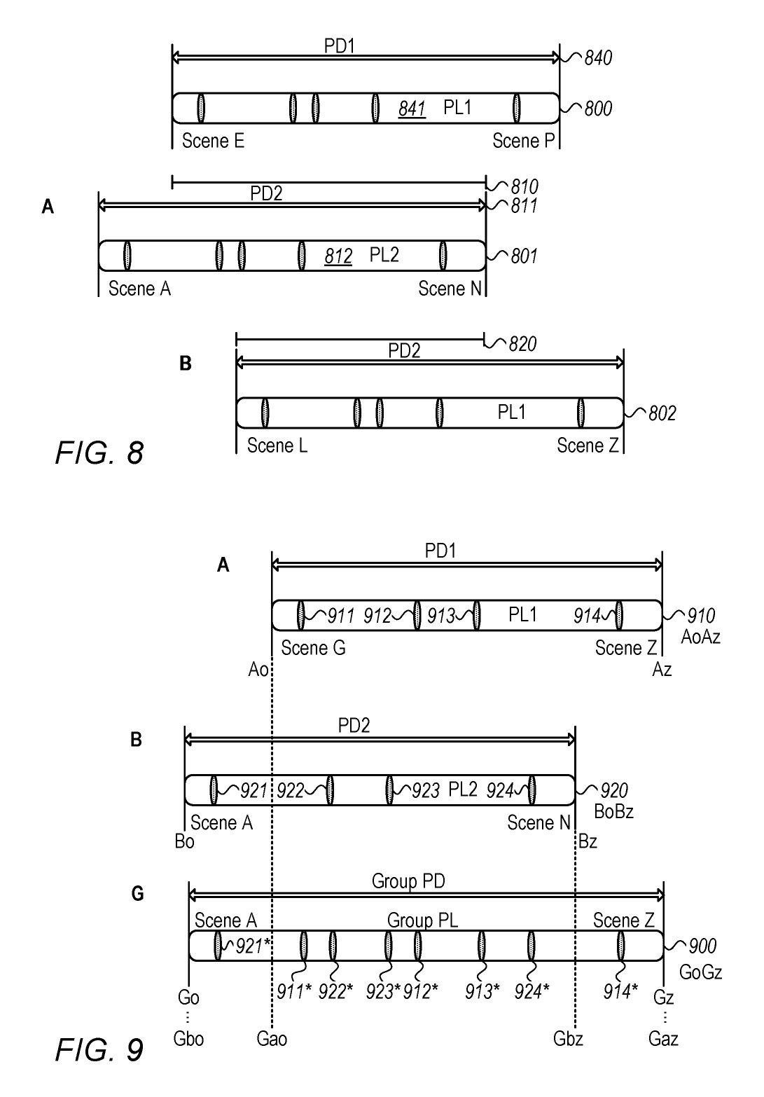

A first progress enabled media may be a fragment of a second, larger progress enabled media. Embodiments of the invention may link between the first progress enabled media (the fragment) and the second progress enabled media (the larger progress enabled media). This may be applicable for a plurality of fragments as described with reference to FIG. 6, FIG. 7 and FIG. 8. Once a link between two or more progress enabled media segments is made, they are grouped into a media group having a media group identifier.

Embodiments of the invention may include two or more media sources or media segments which contain common content, namely, the same content. The two or more media sources do not have to be identical but may include identical parts. The identification of two or more separate media sources having common content may be done by different means and methods, e.g., by automatic computer processing algorithms such as image processing, voice and/or text processing or by human based computation which allows users to point out similar media sources.

While comparing the two or more segments the content itself should be identical for certain duration while other parameters of the media such as quality, bit-rate, resolution, format may not be identical. According to embodiments of the invention, two or more media sources may be grouped and given a single media group identifier such that comments related to a first media source may be presented to a user while he watches a second media source having the same media group identifier. Comments from a first media source may be presented while watching a second media source if the content of the first media source and the second media source are identical entirely or partially as described with references to FIG. 6, FIG. 7, FIG. 8 and FIG. 9.

The term “scene” as used herein refers to the smallest fragment with the smallest unit of measurement of the progress enabled media type, e.g., a frame for a video, a slide for a slide show, a sound with substantially 0 seconds length for audio. The term “segment” as used herein is referred to a fragment of media which may include one or more scenes. According to embodiments of the invention, once identification of two media segments is made, a plurality of relations between media segments may exist.

Reference is made to FIG. 6 which shows a schematic illustration of an exact match of correspondence between two media segments according to embodiments of the invention. A first media segment 600 and a second media segment 601, are represented, respectively by a first progress line 610 and a second progress line 615. An exact match is defined when the media segments are identical, namely are exact duplication while progress line 610 and progress line 615 contain the same content and start and end at an identical scene therefore having an identical PD, e.g., PD1 620 is identical to PD2 625. Embodiments of the invention may allow a variety of precision levels, e.g., precision may be defined by the number of scenes and a difference of one or more scenes may be acceptable.

Reference is made to FIG. 7 which shows a schematic illustration of contained media segments according to embodiments of the invention. A media segment 700 may contain one or more sub media segments. Each of media segments 701, 702 and 703 is contained, enclosed or is a fragment of media segment 700. Media segment 700 is larger than each of the sub segments 701-703 and progress line 710 of media segment 700 is larger than each of progress lines 711 of segment 701, progress line 712 of segment 702 and progress line 713 of segment 703. As media segment 700 contains each of the segments 701, 702 and 703, the PD 720 of segment 700 is longer than PD 721 of segment 701, PD 722 of segment 702 and than PD 723 of segment 703.

Reference is made to FIG. 8 which shows a schematic illustration of overlapping media segments according to embodiments of the invention. A media segment 800 may partially overlap with one or more other media segments, e.g., media segment 801 and/or media segment 802. For example, media segment 800 overlaps with media segment 801 during overlapping interval 810. During overlapping interval 810 the content of media segment 800 and media segment 801 are identical. PD 840 of segment 800 may be identical to or different from PD 811 of segment 801. Progress line 841 of segment 800 is different from the progress line 812 of segment 801 but some of the content is common to both media segments. A plurality of different overlapping segments may exist, for example, media segment 802 overlaps segment 800 during overlapping interval 820. Other overlapping options may exist, for example, segment 800 may have common content with segment 801 and common content with segment 802, while no common content between segment 801 and segment 802.

According to embodiments of the invention, comments related to a first media segment may be presented while watching a second media segment if the content of the first media segment and that of the second media segment are partially or entirely identical, match or correspond. The comments which relate to similar or identical content may be presented to the user.

Reference is now made to FIG. 9 which shows a schematic illustration of a combined media group progress line according to embodiments of the invention. A combined media group progress line 900 may be defined as a merge of two or more media segments of the same media group, e.g., media segment 910 and media segment 920. Media segment 910 may contain a plurality of comments 911, 912, 913 and 914. Media segment 920 may contain a plurality of comments 921, 922, 923 and 924. Combined media group progress line 900 may include all comments from both media segment 910 and media segment 920, namely, comments 911, 912, 913, 914, 921, 922, 923 and 924 each represented by the number in the original media segment and an asterisk sign (*) mark therefore represented by comments 911*, 912*, 913*, 914*, 921*, 922*, 923* and 924*, respectively.

Media segment 910 includes a beginning point A0 and an end point Az, media segment 920 includes a beginning point B0 and an end point Bz and media group progress line 900 includes a beginning point G0 and an end point Gz. Each segment may be defined by a combination of its starting point and its end point, each forming a line segment e.g., line segment 910 may be defined as A0Az, line segment 920 may be defined as B0Bz and line segment 900 may be defined as G0Gz. Each line segment has its own coordinate plane, e.g., A0 !=B0, A0 !=G0. The term “coordinate plane” as used herein refers to a two dimensional surface on which points are plotted and located by their x and y coordinates. Although embodiments of the invention are not limited in this respect, in some embodiments of the invention, coordinate y may equal zero and therefore has no effect on the calculations.

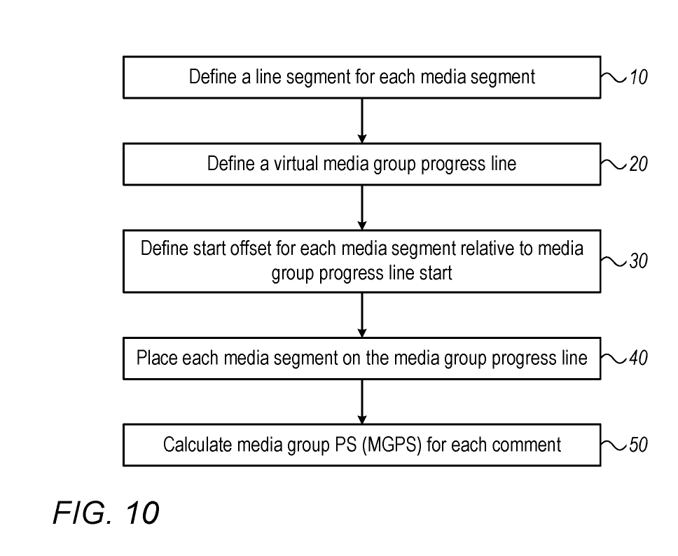

Reference is now made to FIG. 10 which shows a flowchart of a media grouping method according to embodiment of the present invention. As indicated in box 10, each media segment may be defined by a line segment which has a beginning point and an end point, e.g., line segment 910 of FIG. 9 includes a beginning point A0 and an end point Az and line segment 920 of FIG. 9 includes a beginning point B0 and an end point Bz. A virtual media group progress line may be defined as indicated in box 20 by defining a beginning point which is the earliest scene of all the media segments in the group and defining an end point which is the latest scene of all the media segments in the group. For example, with reference to FIG. 9, the beginning point of media group progress line segment 900 is defined as G0 and it is identical to the beginning point B0 of segment 920 which is the earliest beginning point of all the media segments in the group. The end point of media group progress line segment 900 is defined as Gz and it is identical to the end point Az of line segment 910 which is the latest end point of all the line segments in the group. Point Az of line segment 910 is identical in terms of media content to point Gz of line segment 900 but it is different numerically. G0 represents the earliest scene of all the media segments in the group and it may be defined as a zero point, e.g, a time zero or slide zero.

According to embodiments of the invention, the media group progress line segment 900, is placed on a media group coordinate plane, also referred herein to as a “media group plane”. A media group plane may be used for performing time calculations and comment filtering methods, therefore all the media segments of the group may be placed on the media group plane by using time offsets which relate to the time of each of the media segment.

As indicated in box 30, a start point may be defined for each line segment on the media group plane. For example, in the illustration of FIG. 9, Gₐ₀ is defined as the starting point of media segment 910 on the media group line 900. G_{b0} is defined as the starting point of media segment 920 on the media group line 900, as media segment 920 start earliest, G_{b0}=G₀=0. An end point may be defined for each line segment on the media group plane and it may be calculated by adding the duration of the media segment to the media starting point on the media group plane. For example, in the illustration of FIG. 9, G_{bz} is defined as the end point of media segment 920 on the media group line 900, therefore G_{bz}=G_{b0}+PD2. Gaz is defined as the end point of line segment 910 on the media group line 900, as media segment 910 ends last, G_{az}=Gₐ₀+PD1=G_{z}.

As indicated in block 40, every media segment of the group may be placed on the group plane progress line using offsets. By defining a start point and by calculating an end point on the media group plane by adding the media segment duration to the starting point, e.g., for a segment indicated by C, the starting point may be defined by Gc0 and the end point may be calculated by the following formula: Gcz=Gc0+PD3. It should be understood that any number of media segments may be placed on media group plane by defining a starting point, for example, Ga0, Gb0, Gc0, . . . , Gx0 and by calculating an end point using the following formula: Gxz=Gx0+PDz. Each of the media line segments placed on media group plane a, b . . . x, may be marked as following: Gₐ₀G_{az}, G_{b0}G_{bz}, . . . Gₓ₀G_{xz}. Other formulas may be used.

As indicated in block 50, each comment related to each one of the media segments of the group may be given a Media Group PS (MGPS) which is a PS that indicate the location of the comment on the media group plane based on media segment PS and media segment offset, namely, the starting point of the media segment on the media group plane. The MGPS may be calculated according to the following formula: MGPS=Gₓ₀+PS. For example, in FIG. 9, combined media group progress line 900 may include all comments from both media segment 910 and media segment 920, namely, comments 911, 912, 913, 914, 921, 922, 923 and 924 each represented by the number in the original media segment and an asterisk sign (*) mark and therefore represented by comments 911*, 912*, 913*, 914*, 921*, 922*, 923* and 924*, respectively. It should be understood to a person skilled in the art that other operations or sets of operations may be used in accordance with embodiments of the invention and other algorithms or methods may be used for grouping media.

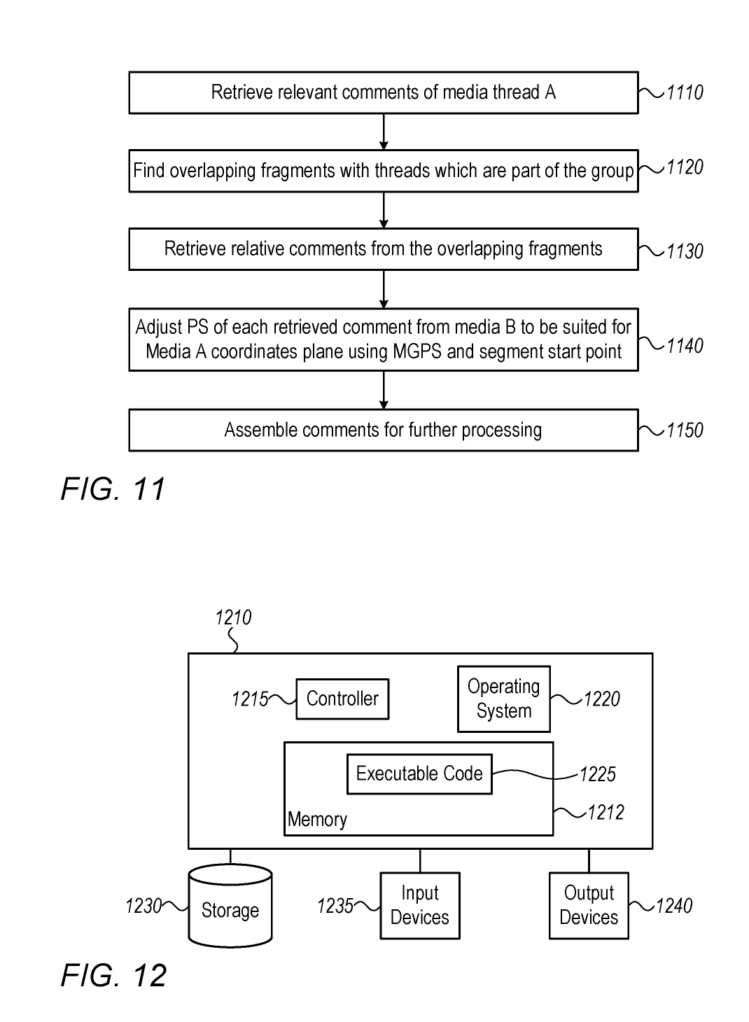

Reference is made to FIG. 11 which shows a flowchart of a comments presentation filtering process for grouped media according to embodiment of the present invention. As indicated in box 1110, comments related to requested media segment A, e.g., line segment 910 of FIG. 9, may be retrieved and as indicated in box 1120, any media segment of the group is checked in order to identify if it overlaps with the requested media segment A. The checking process may include one or more methods and algorithms to identify overlapping between the requested media segment A and any other media segment. An exemplary overlapping identifying algorithm may use the following pseudo code for exemplary media segments a and b,

if (G_{az} − G_{b0} >= 0 and G_{bz} − Gₐ₀ >=0 ) { // overlap

OI₀OI_{z} = [ max(Gₐ₀, G_{b0}), min(G_{az}, G_{bz}) ] // it could be a point
....
} // else: not overlap

As indicated in box 1130, if an overlapping interval was identified, the comments for the overlapping interval of the checked media segment are retrieved from a database and being checked to whether the MGPS of the comments is in the overlapping interval, e.g., OI₀OIz. As indicated in box 1140, if a comment is in the overlapping interval, e, g, in interval OI₀OIz, the PS of each retrieved comment is adjusted to fit to the coordinate plane of the requested media A 910 of FIG. 9, e.g., comments of media segment 920 of FIG. 9 to fit on coordinate plane of media segment A 910 of FIG. 9, the following formula may be used: PS=MGPS−Ga0. As indicated in box 1150, all comments may be assembled for further processing.

Although the invention is not limited in this respect, the described method and process may be performed using similar principles requests for fragments, parts or portions of a certain media segment, e.g., specific show span, as well as for full media segments. In case of requests for fragments overlapping may be checked with only the requested portion of the media segment instead of with the entire media segment.

Reference is made to FIG. 12, showing a high level block diagram of an exemplary computing device according to embodiments of the present invention. Computing device 1210 may include a controller 1215 that may be, for example, a central processing unit processor (CPU), a chip or any suitable computing or computational device, an operating system 1220, a memory 1212, an executable code 1225, a storage 1230, input devices 1235 and output devices 1240. Controller 1215 may be configured to carry out methods described herein, and/or to execute or act as the various modules, units, etc. More than one computing device 1210 may be included, and one or more computing devices 1210 may act as the various components, for example the components shown in FIG. 1. For example media content provider 130, commenting system provider 140, servers 100 and 120, clients 150 and 160 and users 151 and 161 all described with reference to FIG. 1, may be, or may include components of, computing device 1210. For example, by executing executable code 1225 stored in memory 1212, controller 1215 may be configured to carry out methods as described herein.

Operating system 1220 may be or may include any code segment (e.g., one similar to executable code 1225 described herein) designed and/or configured to perform tasks involving coordination, scheduling, arbitration, supervising, controlling or otherwise managing operation of computing device 1210, for example, scheduling execution of software programs or enabling software programs or other modules or units to communicate. Operating system 1220 may be a commercial operating system.

Memory 1212 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 1212 may be or may include a plurality of, possibly different memory units. Memory 1212 may be a computer or processor non-transitory readable medium, or a computer non-transitory storage medium, e.g., a RAM.

Executable code 1225 may be any executable code, e.g., an application, a program, a process, task or script. Executable code 1225 may be executed by controller 1215 possibly under control of operating system 1220. For example, executable code 1225 may be an application that performs the virtual filtering method and content filtering method as described herein. Although, for the sake of clarity, a single item of executable code 1225 is shown in FIG. 12, a system according to embodiments of the invention may include a plurality of executable code segments similar to executable code 1225 that may be loaded into memory 1212 and cause controller 1215 to carry out methods described herein. For example, units or modules described herein (e.g., server 110, server 120, client 150 and client 160 of FIG. 1) may be, or may include, controller 1215 and executable code 1225.

Storage 1230 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content may be stored in storage 1230 and may be loaded from storage 1230 into memory 1212 where it may be processed by controller 1215. In some embodiments, some of the components shown in FIG. 12 may be omitted. For example, memory 1212 may be a non-volatile memory having the storage capacity of storage 1230. Accordingly, although shown as a separate component, storage 1230 may be embedded or included in memory 1212.

Input devices 1235 may be or may include a mouse, a keyboard, a touch screen or pad or any suitable input device. It will be recognized that any suitable number of input devices may be operatively connected to computing device 1210 as shown by block 1235. Output devices 1240 may include one or more displays or monitors, speakers and/or any other suitable output devices. It will be recognized that any suitable number of output devices may be operatively connected to computing device 1210 as shown by block 1240. Any applicable input/output (I/O) devices may be connected to computing device 100 as shown by blocks 1235 and 1240. For example, a wired or wireless network interface card (NIC), a printer, a universal serial bus (USB) device or external hard drive may be included in input devices 1235 and/or output devices 1240.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 1212, computer-executable instructions such as executable code 1225 and a controller such as controller 1215. In some embodiments, memory 1212 is a non-transitory machine-readable medium.

A system according to embodiments of the invention may include components such as, but not limited to, a plurality of central processing units (CPU) or any other suitable multi-purpose or specific processors or controllers (e.g., controllers similar to controller 1215), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 100.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method for displaying a discussion thread related to a progress enabled media comprising:
providing, by one or more media content providers, a progress enabled media to a client via a communication network;
collecting, by a commenting system provider, information related to the progress enabled media;
determining, by the commenting system provider, a unique identifier of the progress enabled media;
providing, by the commenting system provider, a discussion thread related to the progress enabled media according to the unique identifier; and
displaying, by the commenting system provider, the discussion thread to a user.

2. The method of claim 1, wherein a link between the discussion thread and the progress enabled media is independent from the one or more media content providers.

3. The method of claim 1, wherein the discussion thread comprises one or more comments.

4. The method of claim 3, wherein each of the one or more comments comprises a progress stamp to link a comment to a certain position of the progress enabled media.

5. The method of claim 1, wherein displaying the discussion thread to the user is according to a visual filtering process.

6. The method of claim 5, wherein the visual filtering comprises calculating a variable that represents a span of time related to a certain position in the progress enabled media for which comments should be displayed to the user.

7. The method of claim 5, further comprising:
calculating a variable that represents a span of time related to a certain position in the progress enabled media for which comments should be displayed to the user; and
displaying comments related to the certain position in the progress enabled media to the user is according to a content based filtering process.

8. The method of claim 5, further comprising:
calculating a variable that represents a span of time related to a certain position in the progress enabled media for which comments should be displayed to the user; and
displaying comments related to the certain position in the progress enabled media to the user is according to a content based filtering process, wherein the content based filtering process comprises locating one or more comments to be presented to the user based on at least one of: content of the one or more comments and calculated weight of the one or more comments.

9. The method of claim 1, further comprises linking between a first progress enabled media and a second progress enabled media and grouping the first progress enabled media and the second progress enabled media to a media group having a group identifier, wherein the first progress enabled media is a fragment of the second progress enabled media.

10. The method of claim 3, wherein each of the one or more comments is visualized on the progress line using a comment indicator.

11. The method of claim 3, wherein each of the one or more comments is displayed in a draggable and resizable window, that is located next to the progress enabled media.

12. A system for displaying a discussion thread related to a progress enabled media comprising:
a client connected to a communication network;
one or more media content providers, to provide a progress enabled media to the client via the communication network; and
a commenting system provider to collect information related to the progress enabled media, to determine a unique identifier of the progress enabled media, to provide a discussion thread related to the progress enabled media according to the unique identifier and to display the discussion thread to a user connected to the client.

13. The system of claim 12, wherein a link between the discussion thread and the progress enabled media is independent from the one or more media content providers.

14. The system of claim 12, wherein the discussion thread comprises one or more comments.

15. The system of claim 14, wherein each of the one or more comments comprises a progress stamp to link a comment to a certain position of the progress enabled media.

16. The system of claim 12, wherein the commenting system provider is to display the discussion thread to the user according to a visual filtering process.

17. The system of claim 16, wherein the visual filtering comprises calculating a variable that represents a span of time related to a certain position in the content enabled media for which comments should be displayed to the user.

18. The system of claim 12, wherein the commenting system provider is to display the discussion thread to the user according to a content based filtering process.

19. The system of claim 18, wherein the content based filtering process comprises locating one or more comments to be presented to the user, by the commenting system provider, based on content of the one or more comment.

20. The system of claim 12, wherein the content based filtering process is to link between a first progress enabled media and a second progress enabled media and grouping the first progress enabled media and the second progress enabled media to a media group having a group identifier, wherein the first progress enabled media is a fragment of the second progress enabled media.

21. (canceled)

22. (canceled)
